(19) United States
(12) Patent Application Publication
(10) Pub. No.: US 2026/0133004 A1
(43) Pub. Date: May 14, 2026

(54) COMPENSATOR FOR AERIAL PLATFORM PAYLOAD

(71) Applicant: Sig Sauer, Inc., Newington, NH (US)

(72) Inventors: Jonathan D. Lynch, Manchester, NH (US); Jacob R. Schaddel, Newmarket, NH (US); Ryan Wade Scott, West End, NC (US)

(73) Assignee: Sig Sauer, Inc., Newington, NH (US)

(21) Appl. No.: 19/385,375

(22) Filed: Nov. 11, 2025

Related U.S. Application Data
(60) Provisional application No. 63/719,327, filed on Nov. 12, 2024.

(51) Int. Cl. F41A 21/38; B64U 10/13; B64U 20/87; B64U 101/18; F41A 23/02

(52) U.S. Cl. CPC F41A 21/38; B64U 10/13; B64U 20/87; F41A 23/02; B64U 2101/18

(57) ABSTRACT

Examples provide a compensator for a firearm. In one example, a firearm assembly includes a firearm having a barrel defining a projectile bore along a bore axis, an attachment mechanism coupled to the firearm and configured to mount the firearm to a movable platform, and a compensator attached to the barrel. The compensator may have a body that defines at least one compensator port configured to vent a portion of gases exiting the barrel upon firing the firearm. In one example, the compensator is oriented on the barrel to direct the portion of gases vented through the at least one compensator port in a direction to counteract angular recoil forces on the movable platform to which the firearm is mounted, the angular recoil forces being caused upon firing of the firearm.

### CROSS-REFERENCE TO RELATED APPLICATION

This application claims priority to U.S. Provisional Patent Application No. 63/719,327 titled “COMPENSATOR FOR AERIAL PLATFORM PAYLOAD” and filed on Nov. 12, 2024, which is hereby incorporated herein by reference in its entirety.

### FIELD OF THE DISCLOSURE

The present disclosure relates generally to remote-actuated firearms and more specifically to a compensator for use with a firearm mounted on an aerial platform.

### BACKGROUND

A muzzle brake or recoil compensator is a type of muzzle device for a firearm that is designed to reduce muzzle rise or “muzzle flip” by redirecting a portion of propellant gases leaving the barrel. Some compensators can be attached to the barrel, such as threading the device onto a threaded handgun barrel or rifle barrel. Other compensators are integral to the barrel, such as when the barrel defines ports along the length of the barrel to vent gases through corresponding openings in the barrel. Whether using an attachment or using ports in the barrel, the burst of propellant gases is typically directed upward to counter recoil forces that tend to cause muzzle rise upon firing the gun.

### SUMMARY

Aspects and examples are directed to a compensator configured to be mounted to a firearm payload carried by a movable platform, such as an aerial vehicle (e.g., a drone), land vehicle, water vehicle (e.g., a ship, submarine, or other watercraft), or other platform (e.g., a tiltable or otherwise movable platform that is not necessarily a vehicle or part of a vehicle) and used to mitigate pitch, roll, and/or yaw of the movable vehicle caused by firing the firearm. In one example, a firearm includes a barrel defining a projectile bore along a bore axis, and a compensator attached to the barrel. The compensator may include a body having at least one sidewall configured to extend at least partially around a circumference of the barrel. The compensator body is configured to direct venting of at least a portion of discharge gases that exit the barrel upon firing of the firearm so as to reduce positional shifts of a movable platform to which the firearm is mounted caused by the discharge gases. In some examples, the body of the compensator may further include at least one endwall that redirects the discharge gases incident thereon towards one or more compensator ports defined in the compensator body. The at least one endwall may further define a distal opening aligned with the projectile bore to allow passage of a projectile along the bore axis through the distal opening. In some examples, the at least one sidewall includes a first sidewall (or sidewall region) defining at least one compensator port configured to vent the portion of the discharge gases. In some examples, the compensator is oriented on the barrel with the at least one compensator port positioned at an alignment angle relative to an axis that is vertically perpendicular to the bore axis, the alignment angle being in a range of −45°to 45° measured from the axis. In one example, the alignment axis is approximately −15° or 15°.

In some examples, the firearm is mounted to, or otherwise carried by, an unmanned aerial vehicle (UAV), unmanned land or water vehicle, or other unmanned movable platform. Thus, a system may include the firearm and the movable platform. In some examples in which the movable platform is an UAV, the UAV may include one or more airfoils (e.g., wings or rotors). In some examples, the compensator is oriented on the barrel to direct the portion of gases vented through the at least one compensator port in a direction to counteract angular recoil forces on the unmanned movable platform upon firing the firearm. In some examples, the compensator is oriented on the barrel to direct the portion of gases vented through the at least one compensator port in a direction away from the airfoil(s) of the UAV.

Numerous additional examples and variations will be apparent in light of the present disclosure.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the disclosed subject matter.

### BRIEF DESCRIPTION OF THE DRAWINGS

FIG. 1 is an illustration showing a right side view of a firearm in accordance with aspects of the disclosed technology.

FIG. 2 is an illustration showing a perspective view of the firearm of FIG. 1, in accordance with aspects of the disclosed technology.

FIG. 3A is an illustration showing a perspective view of one example of a compensator in accordance with aspects of the disclosed technology.

FIG. 3B is a diagram showing a side perspective view of an example of the compensator of FIG. 3A, in accordance with aspects of the disclosed technology.

FIG. 4 is a block diagram illustrating an example of mounting of a firearm payload to an unmanned aerial vehicle (e.g., a drone), in accordance with aspects of the disclosed technology.

FIG. 5 is a block diagram illustrating an example of a compensator on a firearm barrel, in accordance with aspects of the disclosed technology.

FIG. 6A is a diagram showing an example of a compensator in a first orientation with respect to a firearm barrel, in accordance with aspects of the disclosed technology.

FIG. 6B is a diagram showing the compensator in a second orientation with respect to the firearm barrel.

FIG. 7 is an illustration showing an example of the firearm of FIGS. 1 and 2, with an example of the compensator of FIGS. 3A-B mounted on the barrel in the second orientation and also showing, in block diagram form, a UAV coupled to the mounting bracket of the firearm, in accordance with aspects of the disclosed technology.

FIG. 8 is a block diagram illustrating an example of a system including a compensator with an adjustable orientation, in accordance with aspects of the disclosed technology.

The drawings are for the purpose of illustrating examples; however, it will be understood that variations, including different and/or additional aspects and arrangements thereof, are possible, and that the technology disclosed herein is not limited to the arrangements and/or instrumentality shown in the drawings. For purposes of clarity, not every component may be labeled in every drawing. Furthermore, as will be appreciated, the figures are not necessarily drawn to scale or intended to limit the present disclosure to the specific configurations shown.

### DETAILED DESCRIPTION

Disclosed are techniques and structures related to the operation of remote-actuated firearms. In particular, certain examples relate to techniques for mitigating unwanted motion or positional shifts (e.g., pitch, roll, and/or yaw) of a movable platform (e.g., an aerial platform, such as a drone or other vehicle) caused by forces associated with firing a firearm payload that is mounted to (or carried by) the movable platform.

According to one example, a compensator for a platform-mounted (e.g., drone-mounted) firearm payload comprises a body having at least one sidewall configured to extend at least partially around a circumference of barrel of the firearm and at least one endwall that defines a distal opening aligned with a projectile bore defined by the barrel so as to allow passage of a projectile along a bore axis and through the distal opening. The at least one sidewall may include a first sidewall, or sidewall region, defining at least one compensator port configured to vent a portion of gases exiting the barrel upon firing the firearm. In some examples, the compensator is oriented on the barrel with the compensator port positioned at an alignment angle relative to an axis that is vertically perpendicular to the bore axis, the alignment angle being in a range of −45° to 45° measured from the axis. In some examples, the compensator is oriented on the barrel such that the compensator port vents the portion of gases in a direction to counteract angular recoil on the platform during firing of the firearm.

These and other features are described in more detail below.

### General Overview

Unmanned vehicles (UxVs), such as an unmanned aerial vehicle (UAV; also referred to as a drone), unmanned ground vehicle (UGV), or unmanned underwater vehicle (UUV), for example, can be used for a variety of applications, including intelligence, surveillance, target acquisition, and reconnaissance. Some UxVs carry small arms capable of firing on a target. With the advent of drone technology, remote-actuated (also referred to as remote-fired) weapons have become more common. For example, a firearm or other device can be attached to or carried by a drone and actuated remotely to fire the weapon. For example, an operator runs an aerial vehicle remotely from the ground and can also remotely fire or actuate weapons onboard the aerial vehicle. When a firearm mounted to a UxV (referred to as a firearm payload of the UxV) is fired, the forces that tend to cause muzzle flip and/or recoil can also impact the UxV, potentially causing angular movement (e.g., pitch, roll, and/or yaw) that can disrupt operation of the UxV. For example, in the case of a UAV, the angular movement caused by these forces can disrupt the flight of the UAV. In some instances, the disruptive angular movement of the UAV caused by firing the firearm payload can potentially cause the UAV to crash.

Existing handgun compensators are used to reduce muzzle flip and/or recoil, as described above. However, in such applications, the compensator is configured to redirect propulsion gases directly upward (e.g., perpendicular to path of travel of a bullet leaving the handgun) to counter muzzle rise, or 180 degrees backwards (e.g., in the opposite direction of travel of the bullet) from the grip to reduce recoil. When a firearm is mounted to a UAV or other movable platform, rather than being held by a human operator, “felt” recoil and/or muzzle flip (as would perceived by an operator, were the firearm to be held) may be far less significant than the impact of angular recoil on the operation of the movable platform. Furthermore, depending on the mounting arrangement of the firearm on the movable platform, the direction(s) of compensating forces to mitigate angular recoil, and/or the associated undesirable angular movement of the movable platform, may be significantly different than in the typical case of a held handgun. As a result, existing compensator configurations may be inadequate for use with remote-actuated, platform-mounted firearms. Thus, despite existing approaches to compensators for a handgun, many non-trivial challenges remain with respect to compensators for firearms that are mounted (or configured to be mounted) on movable platforms, such as UxVs.

Accordingly, examples provide a compensator that can be attached to, or incorporated into, a barrel of a firearm payload and configured to mitigate angular movement of the UAV that would otherwise be caused by firing the firearm payload. As described in more detail below, in some examples, the compensator can be configured and oriented to reduce angular recoil in all three rotational directions (e.g., corresponding to pitch, roll, and yaw of the UxV). Orientation of the compensator relative to a bore axis of the firearm can be adjusted based on a combined geometry of the firearm and the UxV and a mounted position and/or orientation of the firearm relative to the UxV, as described further below.

### Compensator Examples

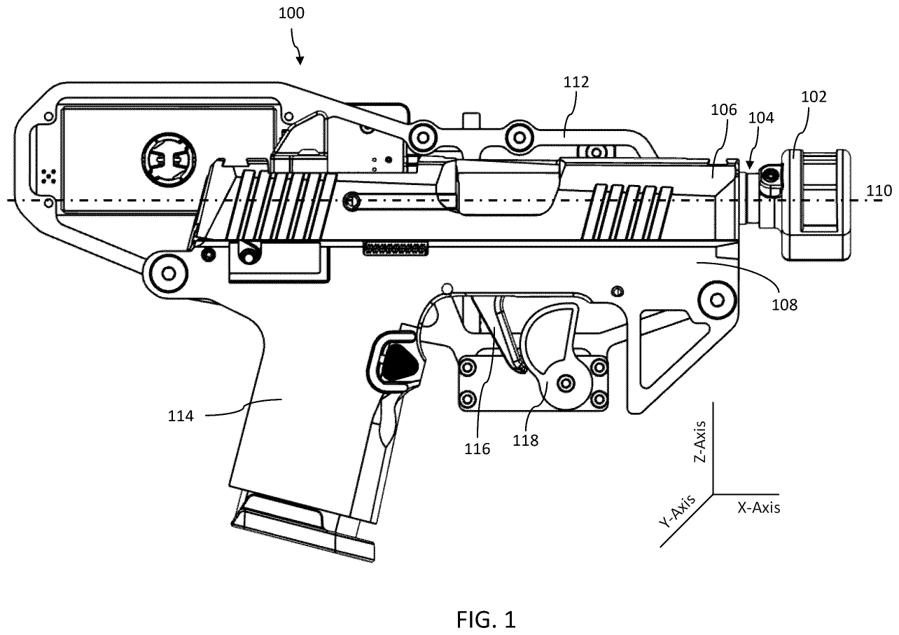

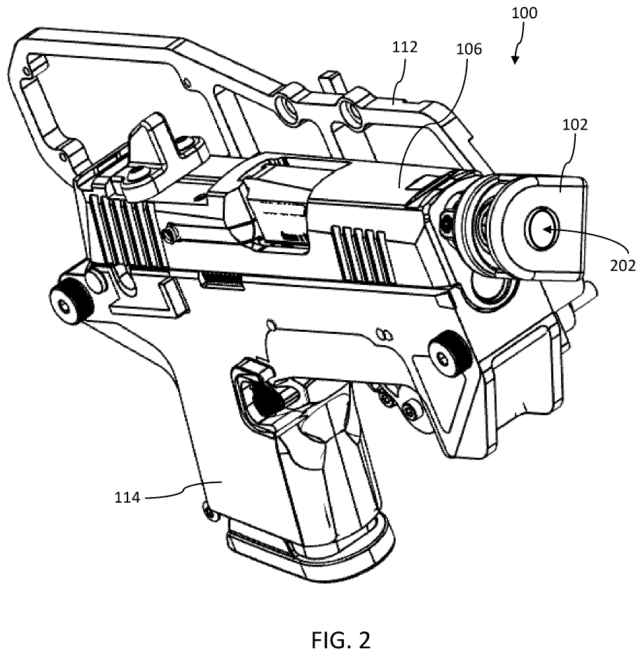

FIG. 1 illustrates a right-side view of a firearm 100 having a compensator 102 coupled to a barrel 104 of the firearm 100, in accordance with certain examples. FIG. 2 illustrates a perspective view of the firearm 100.

In the illustrated examples, the firearm 100 has a slide 106 that is displaceable along a frame 108 in a direction generally parallel to a bore axis 110 of the firearm 100. In some examples, the slide 106 is configured to reciprocate along the frame 108. The frame 108 may be made of metal, such as stainless steel or aluminum, for example. As used herein, the term “frame” refers to the serialized component of a firearm (such as the firearm 100) that houses components of the fire control assembly. In some examples, the firearm 100 further includes a mounting bracket 112 that is coupled to the frame 108. The mounting bracket 112 can be used to secure the firearm 100 to a platform, such as a UxV, for example, and/or to accommodate components of the firearm 100 that are not directly mounted to the frame 108. In some examples, a magazine containing one or more rounds of ammunition can be installed in a magazine well defined by a grip portion 114 that is coupled to the frame 108. When a magazine of ammunition is installed in the magazine well, ammunition can be fed from the magazine into a chamber of the barrel 104.

The firearm 100 includes a trigger 116. When the firearm 100 is fired by pressing (or pulling) the trigger 116, a projectile (e.g., a bullet that has been loaded into the chamber of the barrel 104) is discharged along the bore axis 110. As illustrated in FIG. 2, the barrel 104 defines a projectile bore 202, corresponding to an internal volume of the barrel 104, that extends along the bore axis 110. When the firearm 100 is fired, the projectile travels along the projectile bore 202 through a distal (also referred to as muzzle) end of the barrel 104 and through the compensator 102 to exit the firearm 100. In some examples, the firearm 100 can be configured as a remote-actuated firearm that can be fired (e.g., via one or more control signals) by a remote operator. Accordingly, in such examples, the firearm 100 includes a remote-actuated trigger mechanism 118 that can be used to press (or pull) the trigger 116 to fire the firearm 100.

In the example illustrated in FIG. 1, the firearm 100 is shown oriented with the bore axis 110 extending along the X-axis, and the grip portion 114 extending away from the bore axis 110 in the Z-axis dimension. However, it will be appreciated that the X-Y-Z orientation is shown merely for ease of description with respect to certain features of the firearm 100 and the compensator 102 described below, and is not intended to limit positioning of the firearm 100 in any particular orientation, whether in use or not.

Further, it will be appreciated that, in other examples, the firearm 100 may have a configuration different than the examples shown in FIGS. 1 and 2. For example, the firearm 100 may have a rifle-style configuration, rather than a handgun-style configuration as shown in FIGS. 1 and 2. In some examples, the firearm 100 is a semi-automatic or automatic firearm. The firearm 100 may be hammer-fired or striker-fired. Furthermore, the configuration of various components of the firearm 100, including the frame 108 and/or the mounting bracket 112, may differ from the examples shown in FIGS. 1 and 2. Numerous variations will be apparent in light of this disclosure.

As shown in FIGS. 1 and 2, in some examples, the compensator 102 is attached to the distal end (e.g., muzzle end) of the barrel 104 of the firearm 100. In some examples, the compensator 102 is attached to the barrel 104 by threaded engagement. In other examples, the compensator 102 may be press-fit, glued, or otherwise attached to the barrel 104. In other examples, the compensator 102 can be integrally formed with the barrel 104 and/or with the slide 106. However, in certain instances, providing the compensator 102 as an attachable component may have some benefits, such as allowing the same compensator 102 to be used with multiple firearms 100 and/or allowing for adjustment of the orientation of the compensator 102 on the barrel 104, as described further below.

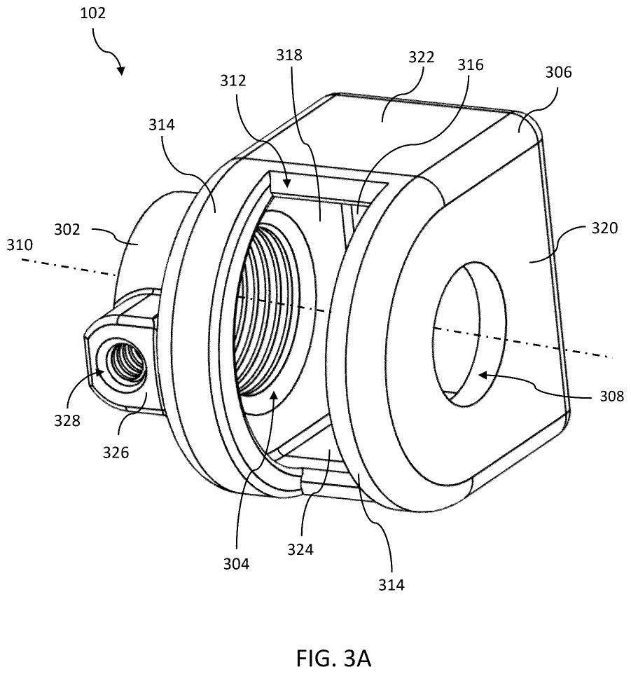

Referring to FIGS. 3A and 3B, an example of the compensator 102 is illustrated. In this example, the compensator 102 includes an attachment portion 302 configured to allow attachment of the compensator 102 to the barrel 104 of the firearm 100. In the illustrated example, the attachment portion 302 is hollow (or defines an interior cavity or attachment opening 330; see FIG. 3B) and is configured to fit around an exterior circumference of the barrel 104, as shown in FIG. 1, for example. However, in other examples, the attachment portion 302 may be configured to fit within the barrel 104, provided that the projectile bore 202 remains sufficiently clear for free passage of a fired projectile therethrough. In the example illustrated in FIGS. 3A and 3B, the compensator 102 is configured to be attached to the barrel 104 by threaded engagement. Accordingly, in this example, at least a portion of an interior surface 304 of the attachment portion 302 is threaded, as shown in FIGS. 3A and 3B, to allow the compensator 102 to be threaded onto a complementary threaded portion of the barrel 104. However, in other examples, the compensator may be attached to the barrel via another mechanism. In some such examples, the attachment portion 302 may not completely surround the exterior circumference of the barrel 104.

In some examples, the compensator 102 includes a body portion 306 having a distal opening 308 formed therein. The distal opening 308 may be positioned in-line with the interior cavity of the attachment portion 302. Thus, the interior cavity of the attachment portion 302 and the distal opening 308 may be centered about, and may optionally be rotationally symmetric about, an axis 310 that extends through the compensator 102, as shown in FIG. 3A. In other examples; however, the interior cavity of the attachment portion 302 and/or the distal opening 308 need not be rotationally symmetric about the axis 310 and/or need not be round/circular. When the compensator 102 is installed on the barrel 104 of the firearm 100, the axis 310 may correspond to the bore axis 110 of the firearm 100. A diameter, or other lateral dimension (e.g., width and/or height in examples in which the distal opening may be roughly rectangular or square), of the distal opening 308 may be the same as, smaller than, or larger than, a diameter of the interior cavity defined by the attachment portion 302. However, the diameter, or other lateral dimension, of the distal opening 308 should be sufficiently large to allow free passage of the projectile therethrough. In some examples, a diameter, or other lateral dimension, of the distal opening 308 may be at least as large as the interior diameter of the barrel 104.

Referring to FIG. 3B, in some examples, the attachment portion 302 extends from the body portion 306 along the axis 310, as also shown in FIGS. 3A and 3B. In some examples, the attachment portion 302 has an exterior height, H1, (measured in a dimension perpendicular to the axis 310, as shown in FIG. 3B) that is smaller than an exterior height, H2, (measured in the same dimension as H1) of the body portion 306. However, in other examples, the height, H1, of the attachment portion 302 may be the same as the height, H2, of the body portion 306.

Referring again to FIG. 3B, the body portion 306 includes one or more ports 312 (referred to herein as compensator ports) defined therein. In the illustrated example, the body portion 306 of the compensator 102 includes a first sidewall region 314 in which the compensator port 312 is formed, and an opposing second sidewall region 316. The body portion 306 further includes a first endwall region 318, from which the attachment portion 302 extends, and a second endwall (also referred to as a distal side or distal endwall) 320 in which the distal opening 308 is formed. The first and second sidewall regions 314, 316 may be part of a single sidewall (e.g., a cylindrical sidewall) that extends between the two endwalls 318, 320. When installed on the barrel 104, the sidewall(s) of the compensator 102 may extend at least partially around a circumference of the barrel 104. In some examples, such as in the example shown in FIG. 3A, the body portion 306 of the compensator 102 may further include third and fourth sidewall regions 322, 324, such that the body portion 306 has a generally six-sided structure, as shown. In such examples, the sidewall regions 314, 316, 322, 324 may be regions of one or more sidewalls, or may be considered individual sidewalls. In the illustrated example, the first sidewall region 314 is curved and the second sidewall region 316 is planar, such that the body portion 306 of the compensator 102 has a “D” shape/configuration. However, in other examples, the body portion 306 may have any of numerous other shapes and/or configurations. For example, the second sidewall region 316 may be curved or have another non-planar profile. In other examples, the first sidewall region 314 may be planar, rather than curved, or may have some other geometric profile. In some examples, the body portion 306 of the compensator can have a cylindrical shape, rather than a D shape, as shown in FIG. 3A. Numerous other variations will be apparent to those skilled in the art, given the benefit of this disclosure.

During use, the compensator port 312 is configured to vent a portion of combustion gases exiting the muzzle end of the barrel 104 in one or more particular directions to counter angular recoil forces that, upon firing of the firearm 100, tend to cause pitch and/or roll of the movable platform (e.g., UAV or other unmanned vehicle) to which the firearm 100 is mounted. In some examples, some combustion gases vent through the compensator port(s) 312, while the remaining portion (sometimes a majority portion) of the combustion gases travel along the bore axis 110 and through the distal opening 308. However, the compensator port(s) 312 can be configured to direct a sufficient portion of the combustion gases in a direction that is angled relative to the bore axis 110 so as to mitigate negative effects of the recoil forces on the movable platform, as described further below. Furthermore, the compensator port(s) 312 can be configured to vent at least some of the combustion gases away from critical components of the UxV, such as away from the airfoil(s) in the case of a UAV, or away from sensors whose operation could be negatively impacted by the combustion gases.

In the example illustrated in FIGS. 3A and 3B, the compensator 102 includes one compensator port 312 formed in the first sidewall region 314. In other examples, the compensator 140 can have two or more ports 312, which may be formed in the first sidewall region 314 and/or other surfaces, sides, or sidewalls of the compensator 102. In some examples, each compensator port 312 can be configured as a slot that extends vertically or laterally through a portion of the first sidewall region 314. In the example illustrated in FIGS. 3A and 3B, the compensator port 312 has a curved rectangular shape by virtue of being configured as a substantially rectangular slot formed in the curved first sidewall region 314. Further, in the illustrated example, the compensator port 312 extends along a majority of the extent of the first sidewall region 314 in the dimension measured between the third and fourth sidewall regions 322, 324. However, in other examples, the compensator port 312 may consume a smaller area of the first sidewall region 314 and may extend over less than a majority portion of the first sidewall region 314 in the dimension extending between the third and fourth sidewall regions 322, 324. In some examples, the compensator port 312 can be replaced by multiple parallel vertically- or laterally-oriented slots, for example. In other examples, the compensator port(s) 312 can have a shape other than a slot, such as an arcuate, circular, semi-circular, trapezoidal, square, or other-shaped opening, a group of openings, or a combination of openings with different shapes. Numerous variations and embodiments will be apparent in light of the present disclosure.

In some examples, the compensator port(s) 312 can be machined or otherwise formed in the body portion 306 of the compensator 102. In other examples, the compensator 102 can be produced by additive manufacturing (e.g., 3D printing), such that the compensator port(s) 312 are formed during formation of the body portion 306 of the compensator 102. In some examples, producing the compensator 102 by additive manufacturing may advantageously allow a high degree of configurability in the shape of the compensator port(s) 312 and various aspects of the compensator 102. For example, using additive manufacturing, surface features on the interior surfaces of one or more of the sidewalls 314, 316, 322, 324, and/or endwalls 318, 320 can be precisely formed to influence flow of the combustion gases within and upon exit from the compensator 102.

Still referring to FIGS. 3A and 3B, in some examples, the attachment portion 302 includes a securement region 326 having one or more fastener opening(s) 328 therein that may accommodate a locking assembly, such as one or more fasteners or other devices. In some examples, the opening 328 extend through the securement region 326 to the interior of the attachment portion 302. As such, a fastener inserted into the opening 328 can contact the barrel 104 when the compensator 102 is positioned on the barrel with the barrel extending at least partially into or through the attachment portion 302. For example, the compensator 102 can be secured to the barrel 104 using one or more fasteners, such as taper pins, threaded pins, or set screws, for example, that extend through the compensator 102 (e.g., via the securement region 326) and engage the barrel 104, such as a flat or recess in the sides of the barrel. In another example, the locking assembly may include a fastener that when advanced moves a yoke into engagement with a circumferential groove on the barrel. In the installed condition, the locking assembly can be tightened to fix the rotational and axial position of the compensator 102. For example, the locking assembly may provide a mechanical stop that prevents rotation of the compensator 102 after the compensator is threaded onto (or otherwise attached to) the barrel 104. Accordingly, the fastener(s) may fixedly secure the compensator 102 to the barrel 104 with a selected orientation of the compensator 102, as described further below. In the illustrated example, an interior surface of the opening 328 is threaded, as shown, to accommodate a threaded fastener; however, in other examples, such as where a different type of fastener is used, the interior surface of the opening 328 may not be threaded. Further, in some examples in which a different mechanism is used to adjust and/or set the orientation of the compensator 102 on the barrel 104, the securement region 326 and/or the opening 328 can be omitted.

Thus, the compensator 102 may have any of numerous configurations in terms of size, shape, structure, number of compensator ports, shape of compensator ports, arrangement of compensator ports, and/or attachment to the firearm barrel 104. However, the compensator 102 can be configured and arranged/oriented on the barrel 104 such that, when the firearm is fired, the compensator 102 directs at least a portion of the combustion/discharge gases in a manner (e.g., one or more directions) designed to mitigate unwanted positional shifts (e.g., unwanted pitch, roll, and/or yaw) in the movable platform (e.g., UxV) to which the firearm is mounted. In some examples, the body portion 306 of the compensator 102 is configured to block or impeded the passage of the gases in undesired/unwanted directions of gas travel and to direct (e.g., via the one or more compensator ports 312) the gases towards one or more desired direction of gas travel. The desired direction(s) of gas travel can be selected to minimize disturbance (e.g., positional shifting) of the moveable platform that would otherwise be caused by the gases and/or to direct the gases away from certain operational components of the moveable platform, such as sensors or rotor(s) or other airfoil(s) in the case of a UAV, for example. By minimizing or reducing disturbances to the movable platform, the risk of damage to the movable platform may be reduced and the recovery time of the system (e.g., the time after one shot is fired until the system is ready to fire the next shot) may be shortened.

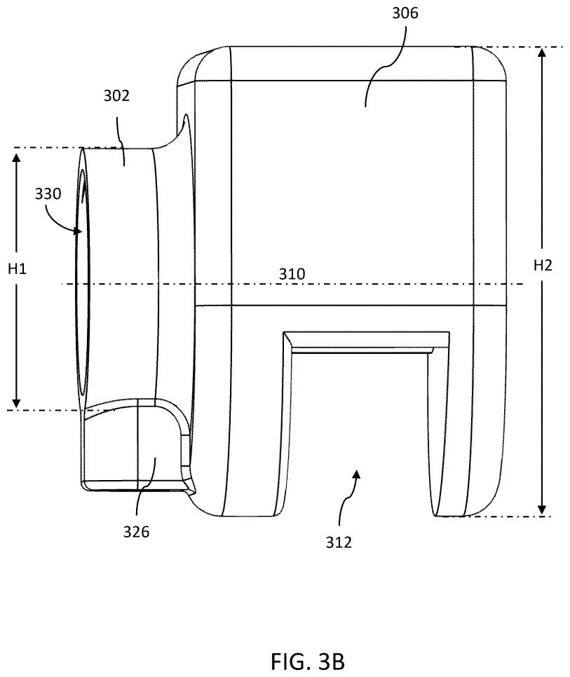

Turning to FIG. 4, illustrated is a block diagram showing mounting of the firearm 100 to a UAV 402. As described above, the firearm 100 can be mounted to the UAV 402 (or another movable platform) via the mounting bracket 112, for example. Thus, the mounting bracket 112 may represent or provide one example of an attachment mechanism that allows the firearm 100 to be mounted to a movable platform. However, in other examples, other attachment mechanisms can be used. In some examples, the UAV 402 include one or more airfoils, such as rotors 404, to assist the UAV in flying. The UAV 402 may further include a camera 406, optionally in combination with one or more other sensors (which may include additional cameras), which may be used for navigation and/or other purposes. In some examples, the camera 406 is used to assist a remote operator in sighting a target for firing the firearm 100. Accordingly, it may be preferable to mount the firearm 100 to the UAV 402 in such a configuration that the barrel 104 is aligned with the camera 406. For example, the camera 406 may have a field of view centered about an axis 408. Accordingly, the firearm 100 can be positioned such that a cross-sectional plane of the projectile bore 202 of the barrel 104 is also centered about the axis 408, as shown in FIG. 4.

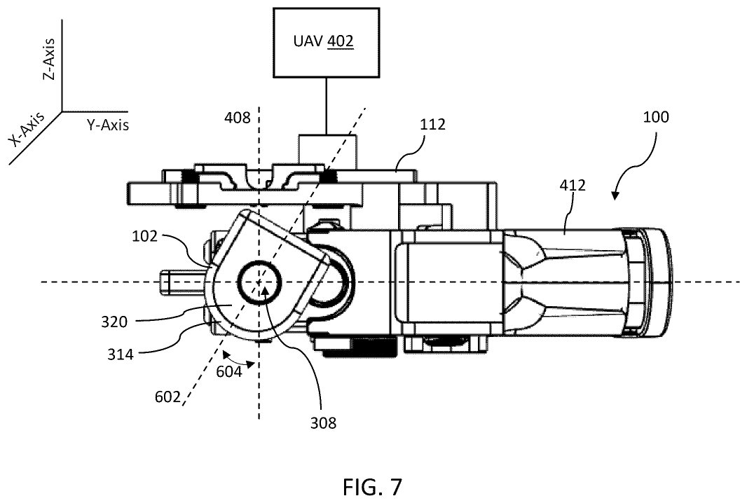

In the illustrated example, the axis 408 extends in the dimension of the Z-axis, which in some instances corresponds to the vertical dimension in real space. Further, in the illustrated example, the firearm 100 is mounted to the UAV 402 such that a body portion 412, which may include the grip portion 114, extends away from the barrel 104 in the dimension of the Y-axis. Thus, in this example, the firearm 100 is oriented “on its side” relative to the orientation shown in FIG. 1. An example of the firearm 100 in this position is also shown in FIG. 7. In these examples, the bore axis 110 extends along the X-axis. In some applications, mounting the firearm 100 to the UAV 402 in this “side” configuration is advantageous; however, in other applications and/or examples, the firearm 100 can be mounted to the UAV 402 (or another movable platform) in a different relative orientation (e.g., in a “vertical” orientation as shown in FIG. 1, or some other orientation). Thus, positioning of the firearm 100 relative to the UAV 402 (or another movable platform), and in three-dimensional space, is not limited to the examples shown in FIGS. 4 and 7.

In some examples, such as when the firearm 100 is mounted to the UAV 402 in the orientation shown in FIGS. 4 and 7, a center of gravity of a combination of the firearm 100 and the UAV 402 is shifted off the axis 408. For example, in the orientation of FIGS. 4 and 7, because the body portion 412 extends away from the axis 408 in the Y-axis dimension, the center of gravity of the combination of the firearm 100 and the UAV 402 is shifted to the right (as illustrated) or left of the axis 408. As a result, when the firearm 100 is fired, angular recoil forces may tend to cause the UAV 402 to roll to the right (or left). In addition, test firings have demonstrated that the angular recoil forces may also tend to cause the UAV 402 to pitch forward and down (in the Z-axis dimension). Unmitigated, these forces can significantly impact the stability of the UAV 402 in flight. Thus, as described above, the compensator 102 can be configured (e.g., through the number, size, shape, and/or positioning of the compensator port(s) 312) and oriented on the barrel 104 to counter the potential effects of angular recoil during firing on the UAV 402.

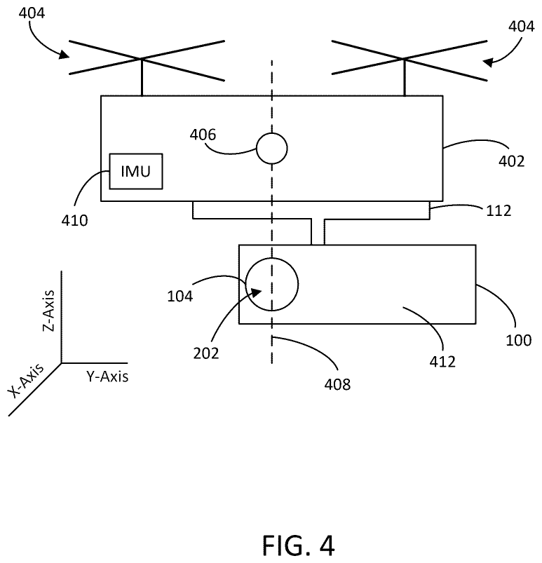

FIG. 5 is a block diagram showing an example of the compensator 102 positioned on the barrel 104. Arrows 502 and 504 in FIG. 5 illustrate an example of flow paths of combustion gases upon firing. In this example, a portion of gases continue to travel along the bore axis 110, in the direction of arrow 502, as the gases exit the muzzle end 506 of the barrel 104 and travel through the distal opening 308 during at least a portion of the firing cycle. Another portion of gases exit through the compensator port 312 in a direction (indicated by arrow 504) that is perpendicular to the bore axis 110 (e.g., downward, as shown in FIG. 5) and/or otherwise angled with respect to the bore axis 110. In some examples, the gases exiting through the compensator port(s) 312 may travel primarily in a downward cone of angles approximately ±60° from perpendicular (90°) relative to both the bore axis 110 and the axis 408, approximately ±50° from perpendicular relative to both the bore axis 110 and the axis 408, ±45° from perpendicular (90°) relative to both the bore axis 110 and the axis 408, or ±30° from perpendicular relative to both the bore axis 110 and the axis 408. The angular cone of travel of the combustion gases through the compensator port(s) 312 may be determined, at least in part, by the size and shape of the compensator port(s) 312 and the orientation of the compensator 102, and therefore of the compensator port(s) 312, relative to the bore axis 110.

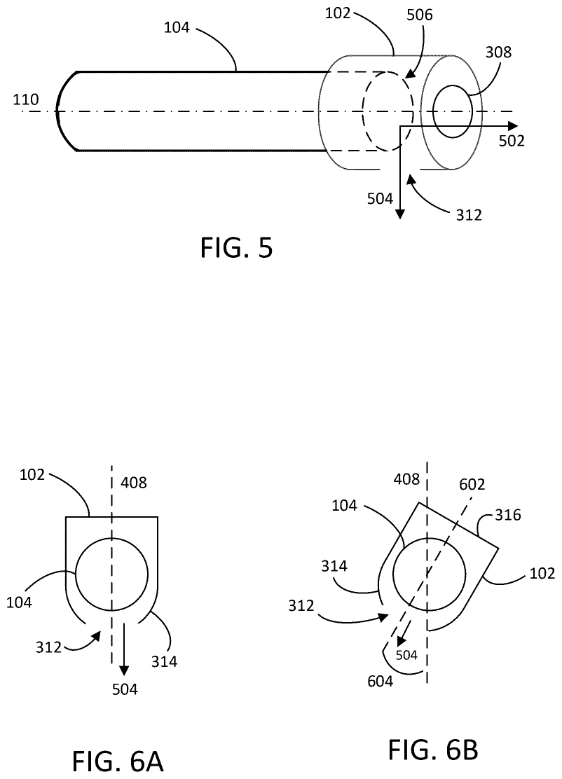

For example, FIG. 6A illustrates an example in which the compensator 102 is positioned and oriented on the barrel 104 such that the compensator port 312 in the first sidewall region 314 is centered about the axis 408, and placed at a “six o'clock” position in the cross-sectional plane of the barrel 104, as shown. Thus, the compensator 102 may be described as being “clocked” to the barrel 104 with the compensator port 312 at the six o'clock position. In this example, the combustion gases exiting the compensator port 312 are directed downward away from the bore axis 110 generally in a direction along the axis 408 (e.g., in a relatively small cone of angles centered about the axis 408). In such examples, the combustion gases exiting the compensator port 312 are directed away from the UAV 402, and in particular away from the rotors 404 of the UAV 402. This arrangement may advantageously prevent, or at least mitigate, unwanted turbulence or disruption in the airflow around the rotors 404 due to the combustion gases exiting the barrel 104 during firing of the firearm 100. In addition, by directing at least a portion of the combustion gases downward and away from the UAV 402, downward pitch of the UAV 402 caused by angular recoil forces from firing the firearm 100 can be counteracted and mitigated. This may improve in-flight stability of the UAV 402 and allow for faster recovery and resighting on a target to prepare for a next shot from the firearm 100.

In some examples, positioning the compensator 102 with the compensator port 312 facing directly downwards (e.g., in the six o'clock position), as shown in FIG. 6A, may sufficiently balance or counteract the angular recoil forces caused by firing the firearm 100 to avoid any significant disruption to the flight of the UAV 402. However, in other examples, it may be preferable to position the compensator 102 such that the compensator port 312 is angled relative to the axis 408, as shown in FIG. 6B, for example. In FIG. 6B, the compensator port 312 is centered about a centerline 602 extending through the first sidewall region 314 and the second sidewall region 316. The centerline 602 is angled relative to the axis 408 by an alignment angle 604. In some examples, the alignment angle 604 is ±15°, ±20°, ±30°, ±45°, ±60°, or some other angle in a the range from −90° to 90°, or more preferably, −45° to 45° In some examples, the compensator 102 can be clocked to the barrel 104 such that the compensator port 312 (or an approximate center thereof) is at the 6:30, 7 o'clock, or 7:30 position (looking into the projection bore 202 from outside the muzzle end 506 of the barrel 104; corresponding, respectively, to the 5:30, 5 o'clock, or 4:30 position looking through the muzzle end 506 of the barrel 104 along the bore axis 110 from inside the barrel 104). An example of an angled orientation of the compensator 102 on the barrel 104 of the firearm 100 is illustrated in FIG. 7. In some examples, positioning the compensator 102 on the barrel 104 such that the alignment angle 604 is between −45° and 45° can advantageously reduce roll of the UAV 402 in response to angular recoil of the firearm 100, as well as reducing pitch of the UAV 402 as described above.

As described above, in some instances, for a given configuration of the compensator 102 (e.g., size, shape, number, and location(s) of the port(s) 312), optimal positioning or orientation of the compensator 102 for mitigating the effects of angular recoil on the UAV 402 (or other movable platform on which the firearm 100 is mounted) may depend in part on the mounting arrangement of the firearm 100 to the UAV 402, as well as on particular configurations of the firearm 100 and/or the UAV 402. Accordingly, in some examples, one or more test firings can be performed for a particular firearm 100 mounted to a particular UxV and data collected regarding pitch, roll, and/or yaw of the UxV caused by angular recoil of the firearm 100 during the firing(s). For example, as shown in FIG. 4, in some examples, the UAV 402 includes an inertial measurement unit (IMU) 410, or other sensor assembly, that can be used to measure pitch, roll, and/or yaw of the UAV. Data may be collected while firing the firearm 100 without the compensator 102, and/or with the compensator 102 positioned in one or more orientations on the barrel 104. Based on the collected data, the orientation of the compensator 102 can be adjusted to select the alignment angle 604. For example, the angle 604 offering optimal performance (e.g., minimal effect on the UAV) can be selected, within reasonable tolerance/accuracy. For example, data can be collected using the IMU 410, and/or other sensors, for shots taken with the compensator 102 positioned at one or more angles 604. The optimal angle 604 may be selected from this group of measurement angles, and may or may not correspond to the absolute optimal angle. In other examples, other approaches, such as simulations or other techniques, can be used to select the angle 604.

In some examples, once the angle 604 has been selected according to, or based on, any chosen method and/or factors, the compensator 102 can be positioned on the barrel 104 and oriented such that the centerline 602 of the compensator port 312 is positioned at the selected angle 604. The compensator 102 can be fixedly secured to the barrel 104 at the chosen orientation. For example, referring again to FIGS. 3A and 3B, in some examples the compensator can be threaded onto the barrel 104 and a fastener (e.g., set screw) via the securement portion 326 can be used to manually secure the compensator 102 at the desired angle 604. In other examples, the firearm 100 and/or the UxV can be provided with a control system to adjust an orientation of the compensator 102 without necessarily requiring manual intervention by an operator.

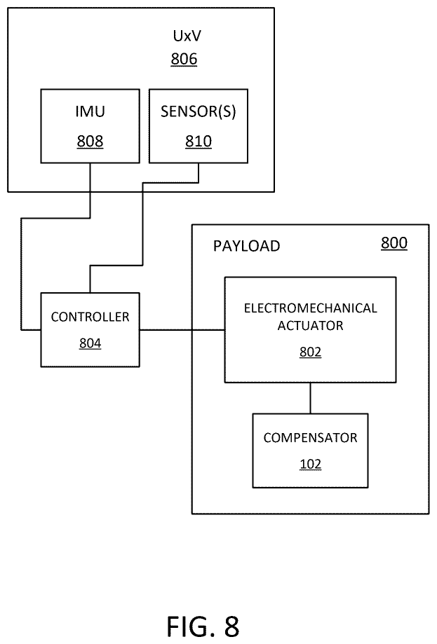

For example, referring to FIG. 8, a payload 800 (which includes the firearm 100) mounted on or otherwise carried by a UxV 806 (e.g., the UAV 402), may include an electromechanical actuator 802 coupled to the compensator 102. In some examples, the electromechanical actuator 802 is part of, or mounted on, the firearm 100 (e.g., secured to the mounting bracket 112 or another component of the firearm 100). The electromechanical actuator may be coupled to a controller 804 that can be either part of the payload 800 or part of the UxV 806, for example. The controller 804 may be coupled to an IMU 808 (e.g., the IMU 410) and/or one or more other sensor(s) 810 (e.g., the camera 406) of the UxV 806 and configured to receive positional/inertial information about the UAV 402. For example, as described above, the IMU 808 may collect pitch, roll, and/or yaw information for the UxV 806 when a shot is fired from the firearm 100. Based on this information, the controller 804 may provide one or more control signals to the electromechanical actuator 802 to cause the electromechanical actuator to adjust an orientation of the compensator 102 on the barrel 104. For example, the electromechanical actuator may include an electric motor (e.g., a solenoid motor or servo motor), and optionally a mechanical linkage between a movable component of the motor and the compensator 102), that when driven by the control signal(s) from the controller 802, can rotate the compensator 102 on the barrel 104 to adjust the angle 604. In this manner, the orientation of the compensator 102 can be dynamically adjusted to mitigate angular recoil on the UxV 806 as data is gathered, for example, during flight of the UAV 402 and firing of the firearm 100 (whether in tests or active engagement). In some examples, the compensator 102 can be manually set to a nominal position/orientation during set-up of the firearm 100 and/or the UxV 806, and thereafter can be adjusted using a system such as that shown in FIG. 8 and described above.

Furthermore, in some examples, the compensator 102 may be attached to the barrel 104 in such a manner that a center of gravity of the compensator 102 biases the compensator 102 to a particular orientation (e.g., rotational position) of the compensator 102 on the barrel 104, which may correspond to a particular alignment angle 604 of at least one compensator port 312. As the movable platform shifts in position (e.g., pitches, rolls, and/or yaws), for example, during flight or other movement of the movable platform, the weight distribution of the firearm 100 and/or the compensator 102 may cause the center of gravity of the compensator 102 to move. Thus, the alignment angle 604 may be automatically adjusted with movement of the movable platform due to the effects of gravity on the compensator 102. In some examples, the controller 804 may operate to either reinforce or override gravity-induced variation in the alignment angle 604, such that the alignment angle 604 can be controlled and oriented as desired, even during movement (e.g., flight) of the movable platform.

Thus, aspects and examples provide a compensator, and method of use thereof, configured to mitigate the effects of angular recoil from firing a UxV-mounted firearm on the UxV. By reducing the effects of angular recoil on the UxV, faster follow-up shots can be achieved and disturbances in the movement (e.g., flight or flight stability), of the UxV can be reduced.

The foregoing description of examples and aspects thereof has been presented for the purposes of illustration and description. It is not intended to be exhaustive or to limit the present disclosure to the precise forms disclosed. Many modifications and variations are possible in light of this disclosure. For example, although some examples described herein refer to a UAV, in other examples, the firearm 100 may be mounted to another type of movable platform (aerial or other) and accordingly, any features or aspects of the compensator 102 and/or firearm 100 described with reference to a UAV are intended to apply to examples in which the firearm 100 is mounted (or mountable) to other types of movable platforms. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein. Unless otherwise stated, “about,” “approximately” or “substantially” preceding a parameter means being within a range of that parameter, such as +/−10 percent of that parameter or +/−5 percent of that parameter. Additionally, references herein to “example” mean that a particular element, structure, or characteristic described in connection with the example can be included in at least one example of the technology described herein. The appearances of these terms in various places in the specification are not necessarily all referring to the same example, nor are separate or alternative examples mutually exclusive of other examples. As such, the examples described herein, explicitly and implicitly understood by one skilled in the art, can be combined with other examples.

### Further Examples

The following examples pertain to further embodiments, from which numerous permutations and configurations will be apparent.

Example 1 is a firearm comprising a barrel defining a projectile bore along a bore axis, and a compensator attached to a muzzle end of the barrel. The compensator includes a body having at least one sidewall configured to extend around a circumference of the barrel and at least one endwall that defines a distal opening aligned with the projectile bore to allow passage of a projectile along the bore axis through the distal opening, wherein the at least one sidewall defines at least one compensator port configured to vent a portion of gases exiting the barrel upon firing the firearm. The compensator is oriented on the barrel with the compensator port positioned at an alignment angle relative to an axis that is vertically perpendicular to the bore axis, the alignment angle being in a range of −45° to 45° measured from the axis.

Example 2 includes the firearm of Example 1, wherein the alignment angle is in a range of 15° to 45° or −45° to −15 °.

Example 3 includes the firearm of one of Examples 1 or 2, wherein the at least one sidewall is curved.

Example 4 includes the firearm of Example 3, wherein the at least one sidewall includes a first sidewall region that defines the at least one compensator port and a second sidewall region positioned opposing the first sidewall region, and wherein the second sidewall region is planar.

Example 5 includes the firearm on Example 4, wherein the at least one endwall comprises a first endwall that defines the distal opening and a second endwall positioned opposing the first endwall, wherein the at least one sidewall extends between the first and second endwalls, and wherein the body of the compensator further includes an attachment portion extending from the second sidewall, the attachment portion being configured to attach the compensator to the barrel.

Example 6 includes the firearm of Example 5, wherein the attachment portion defines an attachment opening configured to fit around a circumference of the barrel.

Example 7 includes the firearm of Example 6, wherein at least a portion of an interior surface of the attachment opening is threaded.

Example 8 includes the firearm of one of Examples 6 or 7, wherein the attachment opening is aligned with the distal opening, and wherein an interior diameter of the attachment opening and of the distal opening is at least as large as a diameter of the projectile bore.

Example 9 includes the firearm of any one of Examples 5-8, wherein the body of the compensator further includes third and fourth sidewall regions, the first, second, third, and fourth sidewall regions extending between the first and second endwalls, and wherein the at least one compensator port extends along a majority of an extent of the first sidewall region between the third and fourth sidewall regions.

Example 10 includes the firearm of any one of Examples 1-9, wherein the at least one compensator port is slot-shaped.

Example 11 includes the firearm of any one of Examples 1-10, wherein the firearm is a semi-automatic firearm or an automatic firearm.

Example 12 includes the firearm of any one of Examples 1-11, wherein the firearm is a remote-actuated firearm.

Example 13 is a system comprising an unmanned aerial vehicle having at least one airfoil, and a firearm attached to the unmanned aerial vehicle. The firearm includes a barrel defining a projectile bore along a bore axis, and a compensator attached to a muzzle end of the barrel. The compensator has a body defining at least one compensator port configured to vent a portion of gases exiting the barrel upon firing the firearm. The compensator is oriented on the barrel to direct the portion of gases vented through the at least one compensator port in a direction to counteract angular recoil forces on the unmanned aerial vehicle upon firing the firearm.

Example 14 includes the system of Example 13, wherein the compensator is oriented on the barrel to direct the portion of gases vented through the at least one compensator port in a direction away from the at least one airfoil of the unmanned aerial vehicle.

Example 15 includes the system of one of Examples 13 or 14, wherein the firearm comprises a frame and a slide displaceable along the frame in a direction substantially parallel to the bore axis, wherein the barrel being coupled to the frame, and wherein the compensator is integral with the slide.

Example 16 includes the system of one of Examples 13 or 14, wherein the body of the compensator comprises at least one sidewall configured to extend around a circumference of the barrel and at least one endwall that defines a distal opening aligned with the projectile bore to allow passage of a projectile along the bore axis through the distal opening, wherein the at least one sidewall includes a first sidewall region defining the at least one compensator port; and wherein the compensator is oriented on the barrel with the compensator port positioned at an alignment angle relative to an axis that is vertically perpendicular to the bore axis, the alignment angle being in a range of −45° to 45° measured from the axis.

Example 17 includes the system of Example 16, wherein the alignment angle is in a range of 15° to 45° or −45° to −15 °.

Example 18 includes the system of one of Examples 16 or 17, wherein the unmanned aerial vehicle comprises a sensor, and wherein the firearm is attached to the unmanned aerial vehicle such that a cross-section of the projectile bore is centered about the axis and spaced apart from the sensor along the axis.

Example 19 includes the system of Example 18, wherein the sensor comprises a camera.

Example 20 includes the system of any one of Examples 16-19, wherein the first sidewall region is curved.

Example 21 includes the system of Example 20, wherein at least one sidewall includes a second sidewall region positioned opposing the first sidewall region, wherein the second sidewall region is planar is planar.

Example 22 includes the system of Example 21, wherein the at least one endwall includes a first endwall that defines the distal opening and a second endwall positioned opposing the first endwall; wherein the at least one sidewall extends between the first and second endwalls; and wherein the body of the compensator comprises an attachment portion extending from the second endwall, the attachment portion being configured to attach the compensator to the barrel.

Example 23 includes the system of Example 22, wherein the attachment portion defines an attachment opening configured to fit around the circumference of the barrel.

Example 24 includes the system of Example 23, wherein at least a portion of an interior surface of the attachment opening is threaded.

Example 25 includes the system of one of Examples 23 or 24, wherein the attachment opening is aligned with the distal opening, and wherein an interior diameter of the attachment opening and of the distal opening is at least as large as a diameter of the projectile bore.

Example 26 includes the system of any one of Examples 22-25, wherein the at least one sidewall further includes third and fourth sidewall regions, the first, second, third, and fourth sidewall regions extending between the first and second endwalls; and wherein the at least one compensator port extends along a majority of an extent of the first sidewall region between the third and fourth sidewall regions.

Example 27 includes the system of any one of Examples 16-26, wherein the unmanned aerial vehicle comprises an inertial measurement unit, and wherein the system further comprises an electromechanical actuator coupled to the compensator, and a controller configured to control the electromechanical actuator, based on sensor data from the inertial measurement unit, to adjust the alignment angle.

Example 28 includes the system of any one of Examples 13-27, wherein the firearm is a semi-automatic firearm or an automatic firearm.

Example 29 includes the system of any one of Examples 13-28, wherein the firearm is a remote-actuated firearm.

Example 30 is a compensator for a drone-mounted firearm, the compensator being configured to vent a portion of gases exiting the firearm barrel upon firing the firearm so as to reduce effects of angular recoil on the drone.

1. A firearm assembly comprising:
a firearm having a barrel defining a projectile bore along a bore axis;
an attachment mechanism coupled to the firearm and configured to mount the firearm to a movable platform; and
a compensator attached to a muzzle end of the barrel, the compensator having a body defining at least one compensator port configured to vent a portion of gases exiting the barrel upon firing the firearm, wherein the compensator is oriented on the barrel to direct the portion of gases vented through the at least one compensator port in a direction to counteract angular recoil forces on the movable platform to which the firearm is mounted, the angular recoil forces being caused upon firing of the firearm.

2. The firearm assembly of claim 1, wherein the body of the compensator includes at least one sidewall configured to extend at least partially around a circumference of the barrel and at least one endwall that defines a distal opening aligned with the projectile bore to allow passage of a projectile along the bore axis through the distal opening.

3. The firearm assembly of claim 2, wherein the compensator is oriented on the barrel with the compensator port positioned at an alignment angle relative to an axis that is vertically perpendicular to the bore axis, the alignment angle being in a range of −45° to 45° measured from the axis.

4. The firearm assembly of claim 2, wherein the at least one sidewall includes:
a first sidewall region defining at least one compensator port configured to vent the portion of the gases exiting the barrel upon firing the firearm, wherein the first sidewall is curved; and
a second sidewall region positioned opposing the first sidewall region, wherein the second sidewall region is planar.

5. The firearm assembly of claim 4, wherein the at least one endwall includes a first endwall that defines the distal opening and a second endwall positioned opposing the first endwall; and
wherein the body of compensator further comprises an attachment portion extending from the second endwall, the attachment portion being configured to attach the compensator to the barrel.

6. The firearm assembly of claim 5, wherein the attachment portion defines an attachment opening configured to fit around the circumference of the barrel.

7. The firearm assembly of claim 6, wherein at least a portion of an interior surface of the attachment opening is threaded.

8. The firearm assembly of claim 7, wherein the attachment opening is aligned with the distal opening; and
wherein an interior diameter of the attachment opening and of the distal opening is at least as large as a diameter of the projectile bore.

9. The firearm assembly of claim 5, wherein the at least one sidewall further includes third and fourth sidewall regions, the first, second, third, and fourth sidewalls extending between the first and second endwalls; and
wherein the at least one compensator port is slot shaped and extends along a majority of an extent of the second sidewall between the third and fourth sidewall regions.

10. A system comprising:
an unmanned aerial vehicle having at least one airfoil; and
a firearm attached to the unmanned aerial vehicle, the firearm including a barrel defining a projectile bore along a bore axis, and a compensator attached to a muzzle end of the barrel, the compensator having a body defining at least one compensator port configured to vent a portion of gases exiting the barrel upon firing the firearm;
wherein the compensator is oriented on the barrel to direct the portion of gases vented through the at least one compensator port in a direction to counteract angular recoil forces on the unmanned aerial vehicle upon firing the firearm.

11. The system of claim 10, wherein the firearm comprises:
a frame, the barrel being coupled to the frame; and
a slide displaceable along the frame in a direction substantially parallel to the bore axis;
wherein the compensator is integral with the slide.

12. The system of claim 10, wherein the compensator is oriented on the barrel to direct the portion of gases vented through the at least one compensator port in a direction away from the at least one airfoil of the unmanned aerial vehicle.

13. The system of claim 10, wherein the body of the compensator comprises at least one sidewall configured to extend at least partially around a circumference of the barrel and at least one endwall that defines a distal opening aligned with the projectile bore to allow passage of a projectile along the bore axis through the distal opening, wherein the at least one sidewall includes a first sidewall region defining the at least one compensator port;
wherein the compensator is oriented on the barrel with the compensator port positioned at an alignment angle relative to an axis that is vertically perpendicular to the bore axis, the alignment angle being in a range of −45° to 45° measured from the axis.

14. The system of claim 12, wherein the unmanned aerial vehicle comprises a sensor; and
wherein the firearm is attached to the unmanned aerial vehicle such that a cross-section of the projectile bore is centered about the axis and spaced apart from the sensor along the axis.

15. The system of claim 14, wherein the sensor comprises a camera.

16. The system of claim 12, wherein:
the first sidewall region is curved;
the at least one sidewall includes a second sidewall region positioned opposing the first sidewall region; and
the second sidewall region is planar.

17. The system of claim 16, wherein the at least one endwall includes a first endwall that defines the distal opening and a second endwall positioned opposing the first endwall;
wherein the at least one sidewall extends between the first and second endwalls; and
wherein the body of the compensator comprises an attachment portion extending from the second endwall, the attachment portion being configured to attach the compensator to the barrel.

18. The system of claim 17, wherein the attachment portion defines an attachment opening configured to fit around the circumference of the barrel; and
wherein at least a portion of an interior surface of the attachment opening is threaded.

19. The system of claim 17, wherein the at least one sidewall further includes third and fourth sidewall regions, the first, second, third, and fourth sidewall regions extending between the first and second endwalls; and
wherein the at least one compensator port extends along a majority of an extent of the first sidewall region between the third and fourth sidewall regions.

20. The system of claim 12, wherein the compensator is oriented on the barrel with the compensator port positioned at an alignment angle relative to an axis that is vertically perpendicular to the bore axis; and
wherein the unmanned aerial vehicle comprises an inertial measurement unit, the system further comprising:
an electromechanical actuator coupled to the compensator; and
a controller configured to control the electromechanical actuator, based on sensor data from the inertial measurement unit, to adjust the alignment angle.
